(19) United States
(12) Patent Application Publication
(10) Pub. No.: US 2026/0149750 A1
(43) Pub. Date: May 28, 2026

(54) DYNAMIC AUDIENCE MANAGEMENT FOR OMNI-CHANNEL COMMUNICATIONS

(71) Applicant: Twilio Inc., San Fancisco, CA (US)

(72) Inventors: Stanley Carl Lemon, San Francisco, CA (US); Ankita Sharma, San Francisco, CA (US); David Moses Lee, San Francisco, CA (US); Igor Pletnjov, San Francisco, CA (US); Jermaine Chan, San Francisco, CA (US); John Romano, San Francisco, CA (US); Kaspar Vaus, San Francisco, CA (US); Matteo Agius-D'Arrigo, San Francisco, CA (US); Oleksander Malinovski, San Francisco, CA (US); Parth Nagori, San Francisco, CA (US); Pranali Awasekar, San Francisco, CA (US); Sumit Dhungel, San Francisco, CA (US); Vamshi Nagabandi, San Francisco, CA (US); Antoine Gosselin, San Francisco, CA (US)

(21) Appl. No.: 19/175,862

(22) Filed: Apr. 10, 2025

Related U.S. Application Data
(60) Provisional application No. 63/724,734, filed on Nov. 25, 2024.

(51) Int. Cl. H04L 67/141; H04L 51/214; H04L 67/306

(52) U.S. Cl. CPC H04L 67/141; H04L 51/214; H04L 67/306

(57) ABSTRACT

A method for dynamic audience management for omni-channel communications includes receiving an API request to create a messaging audience. The API request specifies values of parameters of the messaging audience. Based on the specified parameter values, a filter definition including criteria for selecting members of the audience from a database is generated. A second API request to transmit a communication to the messaging audience is received. The request specifies a messaging audience generation mode represented by either an ad-hoc audience generation mode or a snapshot audience generation mode. Responsive to determining the mode is the ad-hoc audience generation mode, an audience is generated by applying the filter definition to identify recipients satisfying the criteria. A message including the communication is then transmitted to communication channels corresponding to the identified recipients.

### CROSS-REFERENCE TO RELATED APPLICATIONS

The present application claims priority to U.S. Provisional Patent Application No. 63/724,734, filed Nov. 25, 2024, the entire contents of which is being incorporated herein by reference.

### TECHNICAL FIELD

Aspects and embodiments of the present disclosure relate to communication services platforms, and in particular to audience management for communication services platforms.

### BACKGROUND

Communication services platforms can offer various messaging services to users, such as tools that enable sending and/or receiving bulk messages or messages targeted to individual recipients.

### BRIEF DESCRIPTION OF DRAWINGS

Various embodiments in accordance with the present disclosure will be described with reference to the drawings, in which:

FIG. 1 is a block diagram of an example system architecture for audience management for communication services platforms, in accordance with an embodiment;

FIG. 2 is a schematic diagram illustrating channel selection, in accordance with an embodiment;

FIG. 3 is a block diagram of an example omni-channel communication component, in accordance with an embodiment;

FIG. 4 is a flow diagram of an example method for audience management, in accordance with an embodiment;

FIGS. 5A and 5B are a flow diagram of an example method for audience management for communication services platforms; and

FIG. 6 illustrates an example computer system, in accordance with an embodiment.

### DETAILED DESCRIPTION

Communication services platforms can offer various messaging services to users, such as tools that enable sending and/or receiving bulk messages or messages targeted to individual recipients. Communication services platforms can support a variety of communication channels. Communications channels can refer to the various communication methods, technologies, and platforms through which another platform enables interactions between clients and their end users. Examples of channels include Short Messaging Service (SMS), Multimedia Messaging Service (MMS), Rich Communication Services (RCS) (including, e.g., RCS Business Messaging (RBM)), voice calls (via PSTN, cellular, VoIP, or similar), video calls, instant messaging (e.g., WhatsApp, Facebook Messenger), electronic mail, and others. Communication services platforms can provide a layer of abstraction that hides the nuances of each of these channels and provides a uniform interface to users. Customers (e.g., users) of a communication services platform can use the communication services platform to engage with their end users through the platform's messaging tools without having to understand the details of each underlying channel.

A communication services platform can face challenges related to managing audiences for communications at scale. Audience management may rely on static recipient lists that quickly become outdated or require manual maintenance. As data privacy regulations and recipient preferences evolve, communication systems need mechanisms to filter and segment audiences based on complex criteria. Moreover, enterprises frequently need to target communications based on recipient attributes that change over time, such as engagement patterns or demographic information. The ability to update audience membership as these attributes change can improve communication relevance and effectiveness while reducing administrative overhead.

Additionally, managing audience communications at scale presents significant technical challenges, including optimizing database performance when evaluating complex filters across millions of contacts, maintaining system stability during large-scale transmissions, and providing real-time visibility into operation progress. These challenges are compounded when communications need to be personalized for each recipient and delivered through their preferred channels while complying with regional regulations governing electronic communications, which present another significant challenge for communication services platforms. Different jurisdictions have varying requirements regarding consent, timing restrictions, and content limitations across different communication channels. Organizations operating across multiple regions need to navigate these complex regulatory environments while still attempting to deliver effective communications.

Aspects of the present disclosure address these and other challenges by providing a platform that exhibits an omnichannel communication API, which allows a customer of the platform to submit requests for defining, managing, and communicating with dynamically defined audiences. The requests would identify the audience (e.g., by their name or other alphanumeric identifier for the audience and/or recipients of the audience) without specifying any particular communication endpoint identifiers (e.g., phone numbers, email addresses, etc.) associated with recipients of the audience. The platform, which has access to the recipients' information, selects a communication channel, examples of which include SMS, MMS, RCS, RBM, voice calls (via PSTN, cellular, VoIP, or similar), video calls, instant messaging (e.g., WhatsApp, Facebook Messenger) and electronic mail. The selected communication channel is expected to optimize end user engagement, which may be measured by an engagement metric that reflects specific action(s) performed by the recipients in response to receiving the message. The platform can support distinct audience types, including, for example: (i) dynamic audiences that are created by applying filter definitions to identify recipients satisfying specified criteria at the time of message transmission; and (ii) snapshot audiences that capture a point-in-time view of qualifying recipients, which can be reused for subsequent communications. By using communication engagement data and filtering mechanisms, the system can effectively optimize message delivery strategies while ensuring regulatory compliance. This is particularly valuable in time-sensitive scenarios where message delivery is critical, such as account security notifications, service disruption alerts, or important transactional communications.

Thus, the technical effect includes improved audience management and message delivery, increasing message conversion rates, and improving user engagement, as well as improving reliability and reducing costs associated with delivering messages. By supporting complex audience definitions, designating optimized filterable fields with appropriate database indexes, enforcing jurisdiction-specific filtering and scheduling rules, and tracking engagement metrics for continuous optimization, the system can ensure that communications are highly targeted, personalized, and compliant. Unlike communication systems that rely on predefined, static recipient lists, these techniques can dynamically respond to individual preferences and engagement patterns, improving message delivery success rates while navigating the complex regulatory environments across different regions.

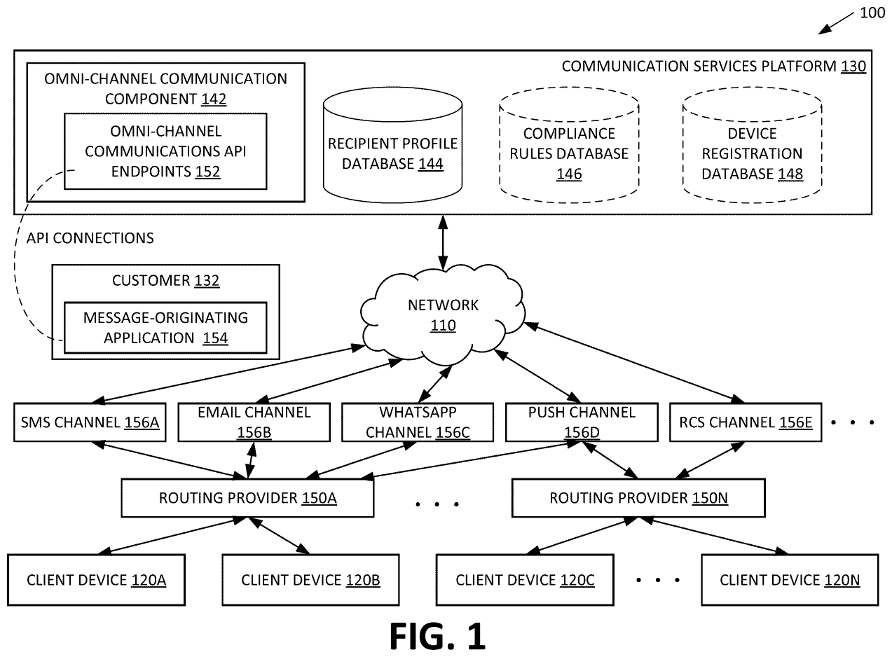

FIG. 1 is a block diagram of an example system architecture 100 for audience management for communication services platforms, in accordance with an embodiment. System architecture 100 (also referred to as “system” herein) includes network 110, client devices 120A-N, a communication service platform 130, a customer 132, and routing providers 150A-N. In various embodiments, system 100 can include more or fewer components in different configurations than those depicted in FIG. 1.

Network 110 can include a public network (e.g., the Internet), a private network (e.g., a LAN, a WAN, a VPN, an enterprise network), a wired network (e.g., Ethernet), a wireless network (e.g., an 802.11 Wi-Fi network), a cellular network (e.g., a 5G network), routers, hubs, switches, server computers, or a combination thereof. Network 110 or components thereof can be associated with different organizations in various embodiments. For example, components of network 110 can be associated with Internet Service Providers (ISPs), mobile or cellular carriers, cloud platform or software-as-a-service (SaaS) providers, private or public enterprises, private households, or communities, etc. In some embodiments, network 110 (or a component thereof) can be a physical or virtual interconnect within a single device, such as a PCIe bus, a messaging system, or an API.

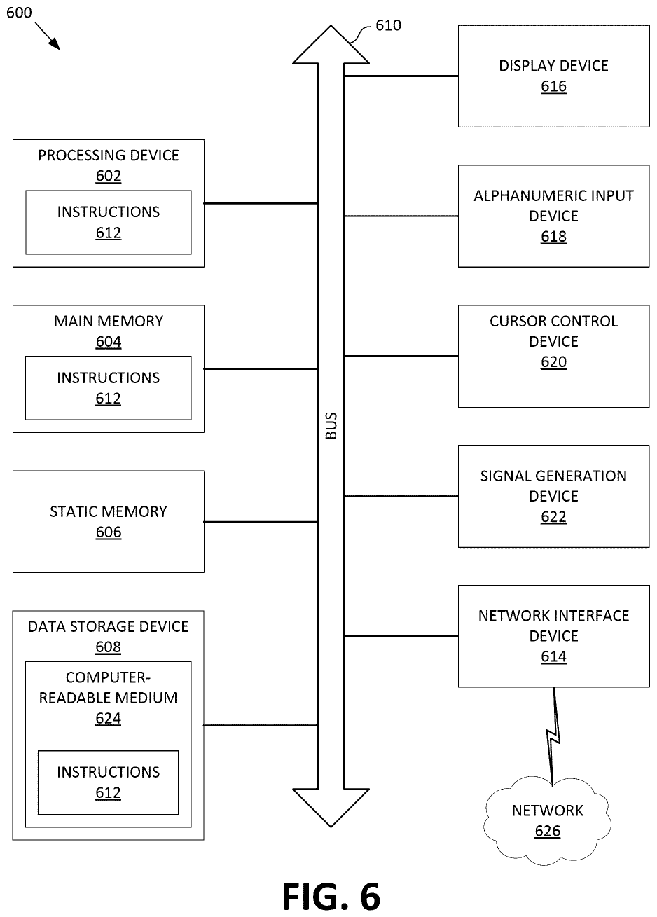

Client devices 120A-N can be personal computers (PCs), laptops, notebook computers, mobile phones, smartphones, tablet computers, digital assistants, network-connected televisions (e.g., smart TVs), or any other computing devices. The computer system of FIG. 6 can be an example of a client device. In various embodiments, client devices 120A-N can also be referred to as “user devices” or “recipient devices.” In some embodiments, a client device of client devices 120A-N can be a destination of a message and can be associated with a destination identifier such as a phone number, a username, and email address, or similar. Client devices 120A-N can run an operating system (OS) that manages hardware and software of the client devices. Client devices 120A-N can further include a web browser, application, or other software for receiving messages. Client devices 120A-N can be used by users such as recipients of messages, who can be end-users of one or more message-originating entities, each of which in turn can be a customer of the communication services platform). In general, and as described below, functions described in embodiments as being performed by a message-originating entity (e.g., a customer of the communication services platform), such as customer 132, and/or communication services platform 130 can also or alternatively be performed on client devices 120A-N in other embodiments. In addition, the functionality attributed to a particular component can be performed by different or multiple components operating together.

Each of communication services platform 130 and customer 132 can be server, such as a rackmount server, a router computer, a personal computer, a portable digital assistant, a mobile phone, a laptop computer, a tablet computer, a netbook, a desktop computer, a virtual machine (VM), etc., or any combination of the above. The computer system of FIG. 6 can be an example of a server. In various embodiments, each of communication services platform 130 and customer 132 can be several computing devices, such as multiple rackmount servers in a data center(s) or multiple VMs in a cloud platform. In some embodiments, functions provided by communication services platform 130 and customer 132 can alternatively be provided by a single server device.

Customer 132 can implement message-originating application 154. Message-originating application 154 can be implemented by a hardware (e.g., circuitry, dedicated logic, etc.) or software (e.g., code, libraries, firmware, etc.) tool of a message-originating entity, such as a customer of the communication services platform 130, that sends messages to destinations and/or recipients, such as client devices 120A-N. The customer can be a person, business, company, and/or any other type of entity that uses system 100 to transmit messages to intended recipients. Message-originating application 154 can send messages to destinations and/or recipients using communication services platform 130. For example, message-originating application 154 can send informational messages (e.g., links to content, promotions), authentication messages (e.g., one-time passcodes, password resets), or other types of messages to client devices 120A-N via communication services platform 130. The customer 132 can use the functionality of system 100 as part of a service provided by the customer 132. The customer 132 may provide various types of services to its end users, such as a banking service, travel service, retail service, and the like. API calls represent the interface through which message-originating application 154 can communicate with communication services platform 130, making function calls to request message delivery services.

Communication services platform 130 includes an omni-channel communication component 142, which may in turn include omni-channel communications API endpoints 152, and a recipient profile database 144. Omni-channel communication refers to a unified approach for transmitting messages across multiple communication channels (e.g., SMS, MMS, RCS, voice calls, instant messaging, and email) where the system intelligently selects the channel that would optimize a chosen channel selection metric (e.g., a recipient engagement metric, a performance metric, a cost-based metric, etc.). This approach enables sending messages to recipients by their identity rather than specific endpoints. In some embodiments, communication services platform 130 can also include a compliance rules database 146 and/or a device registration database 148. Omni-channel communication component 142 can be a hardware or software tool that receives messages addressed to one or more destinations/recipients and sends the messages to their respective destinations/recipients using one or more routing providers. For example, omni-channel communication component 142 can receive a message from message-originating application 154 and can send the received message to one or more of client devices 120A-N using one or more of routing providers 150A-N, via one or more channels 156.

Recipient profile database 144 stores profiles for message recipients, including their communication channel addresses and historical engagement data across different channels. This database supports the platform's ability to optimize channel selection based on recipient behavior patterns. Compliance rules database 146 contains regulatory requirements for different jurisdictions, allowing the system to filter available communication channels based on applicable regional rules regarding consent, timing restrictions, and content limitations. Device registration database 148 can track active devices associated with recipients, enabling precise targeting of specific devices based on recent activity metrics for push notification channels. The recipient profile database 144 can also store custom fields and attributes associated with recipients, which can be utilized for personalization of messages and grouping recipients into audience segments with similar characteristics.

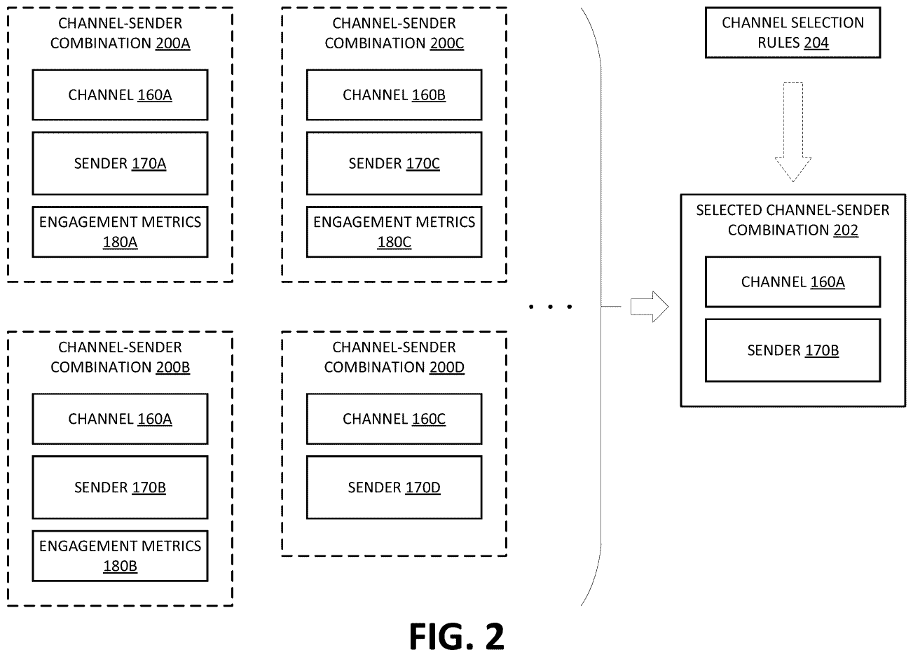

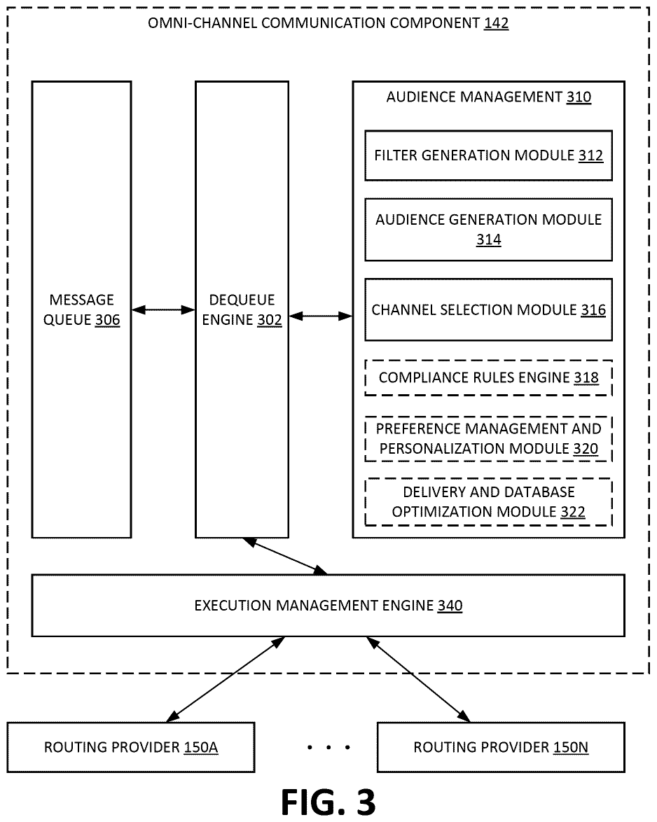

In some embodiments, omni-channel communication component 142 can identify one or more sending options for the destination(s), such as various combinations of communication channels and senders. Examples of senders include an originating phone number (e.g., 10-digit long code or short phone number for SMS), an originating username, an originating email address, a Verified Sender Identity (e.g., for RCS) or similar. Omni-channel communication component 142 can determine one or more metrics for each sending option (e.g., based on feedback data collected from routing providers) and rank the sending options based on the metrics. For example, omni-channel communication component 142 can rank sending options based on message conversion rates, message delivery costs, etc. Omni-channel communication component 142 can select a sending option having an optimal ranking (e.g., highest ranking, lowest ranking, ranking exceeding a threshold value) for sending the message, such as a sending option having the highest conversion rate or lowest maximum message delivery cost. Sending options are further described with reference to FIG. 2. An example omni-channel communication component is further described with reference to FIG. 3.

Routing providers 150A-N can each be an entity for routing messages to recipients. Examples of routing providers include telecommunication providers (e.g., cellular carriers), instant messaging platforms, email providers, and others. Each of routing providers 150A-N can be associated with a physical or virtual destination, such as a geographic region, a Mobile Country Code (MCC)/Mobile Network Code (MNC) tuple, a domain name, or similar.

Message-originating application 154 can communicate with omni-channel communication component 142 using one or more function calls, such as application programming interface (API) function calls (also referred to as “API calls” herein). For example, the one or more function calls can be identified in a request using one or more application layer protocols, such a HyperText Transfer Protocol (HTTP) (or HTTP secure (HTTPS)), and that are sent to omni-channel communication component 142 from message-originating application 154. In some embodiments, omni-channel communication component 142 can respond to the requests from message-originating application 154 by using one or more API responses using an application layer protocol. Similarly, omni-channel communication component 142 can communicate with one or more of routing providers 150A-N using API function calls. Examples of APIs that can be used include a REST (Representational State Transfer) API, a GraphQL API, or a SOAP (Simple Object Access Protocol) API, among others. Omni-channel communication component 142 can include API endpoints 152 that receive and process API calls from message-originating application 154. API connections are established between communication services platform 130 and customer 132, facilitating the communication between message-originating application 154 and omni-channel communication component 142 through API calls and API endpoints 152. These connections enable the message-originating entity to request message delivery services and receive status updates about message transmission and recipient engagement.

Channels 156 represent the various communication methods available for message delivery. These can include, for example, SMS channel 156A for text messaging, email channel 156B for electronic mail communications, WhatsApp channel 156C for instant messaging, push channel 156D for application notifications, RCS channel 156E for rich communication services, and potentially other channels (e.g., MMS, voice calls, video calls, instant messaging applications). The omni-channel communication component 142 can select the optimal channel for each message based on recipient profiles, historical engagement data, and/or compliance requirements.

This architecture enables the intelligent routing of messages by analyzing recipient-specific engagement data, complying with regional regulations, and/or implementing effective fallback mechanisms when delivery failures occur. By leveraging the databases (recipient profiles, compliance rules, and device registration) and the flexible API framework, the system can dynamically adapt to changing recipient behaviors and preferences, improving message delivery success rates while optimizing resource utilization.

In some embodiments, omni-channel communication component 142 can implement a batch processing mechanism that optimizes the sending of same or similar messages to large numbers of recipients. For example, the system may support sending identical or personalized messages to, e.g., thousands of recipients per API call. For even larger campaigns, the system can define audience segments of e.g., millions of recipients based on stored recipient profiles, allowing for efficient bulk messaging while maintaining personalization capabilities. The batch processing mechanism may be channel-optimized and/or use placeholders that are filled in (for each recipient or a subgroup of recipients), like multicast mode.

In some embodiments, omni-channel communication component 142 provides different message personalization options. For smaller batches, the component can support inline variables where recipient-specific variables can be included directly in the API request. This allows for personalization of, e.g., thousands of messages per request. For larger volumes, the platform can use stored contact attributes, enabling personalization to, e.g., one million recipients in a single request using audience-based messaging. Template variables can reference contact fields using a syntax like ${CommunicationPlatform.Contact.first_name} or ${CommunicationPlatform.Contact.custom_fields.field_name}. Default values may be provided for cases where recipient data may be incomplete.

In situations in which the systems discussed here collect personal information about users, or may make use of personal information, the users can be provided with an opportunity to control whether message-originating service 132, communication services platform 142, and/or routing providers 150A-N collect user information, or to control whether and/or how to receive content from the above components that may be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the above components.

FIG. 2 is a schematic diagram illustrating channel selection, in accordance with an embodiment. The example shows channel-sender combinations 200A, 200B, 200C and 200D. Each channel-sender combination includes a channel. Channels 160A-C can each be a mode of communication or a messaging technology for communicating information between message originating entities and message recipients. Examples of channels can include Short Messaging Service (SMS), Multimedia Messaging Service (MMS), Rich Communication Services (RCS) (including, e.g., RCS Business Messaging or RBM), voice calls (via PSTN, cellular, VoIP, or similar), video calls, instant messaging (e.g., WhatsApp), email, and others. Channels can be synchronous (e.g., voice, video) and/or asynchronous (e.g., SMS, email). Channels can be used to transmit messages over shared media such as network 110 or dedicated media such as a Public Switched Telephone Network (PSTN). Different channels can be associated with other shared or distinguishing characteristics not described herein.

Each channel is associated with one or more senders. In the example shown in FIG. 2, the channel 160A is associated with a sender 170A and a sender 170B, whereas the channel 160B is associated with only one sender 170C and the channel 160C is associated with only one sender 170D. Senders 170A-D can each be an identifier of a communication endpoint used by a communication services platform to send a message. Examples of senders include an originating phone number (e.g., 10-digit long code or short phone number for SMS), an originating username, an originating email address, a Verified Sender Identity (e.g., for RCS) or similar. In some embodiments, a message sent using one of senders 170A-D can be routed to a destination or recipient using one of routing providers 150A-N.

In some embodiments, senders 170A-D can be organized into sender pools, which are groups of senders that can be used collectively to increase throughput or enable mixed channel messaging. A sender pool may contain senders from multiple channels (e.g., SMS numbers, WhatsApp business accounts, and RCS agents), allowing the system to select the optimal sender from the pool based on message requirements, recipient preferences, and current performance metrics. Each message is sent using a sender, which may be selected from a pool. The sender pool can be customer-specific, customer-owned, or provided by the communication services platform. The system can automatically attempt delivery using the highest fidelity channel available for each recipient, with automatic fallback to alternative channels when necessary.

In some embodiments, each routing provider and/or channel can exhibit varying levels of performance. For example, the likelihood that a message will be successfully delivered to or engaged with by the recipient can vary among the routing providers and channels. Further, the performance of each sender and/or channel can vary over time. Senders using multiple channels (e.g., RCS with SMS fallback) can similarly provide varying performance.

Each channel-sender combination may be associated with a corresponding engagement metrics. Some channel-sender combinations may not have associated engagement metric. Engagement metrics can include historical data on delivery success rates, read confirmations, response times, and conversion rates for this channel-sender combination. In FIG. 2, channel-sender combination 200A is associated with engagement metrics 180A, channel-sender combination 200B is associated with engagement metrics 180B, channel-sender combination 200C is associated with engagement metrics 180C, but channel-sender combination 200D does not have an associated engagement metrics. Engagement metrics are recipient-specific, so FIG. 2 may be viewed as a recipient-specific view of the channel selection data.

In some embodiments, the channel selection process compares the engagement metric values for all available channel-sender combinations for a particular recipient and selects the channel-sender combination that has the optimal value of the metric. For some channels (e.g., channel 160B), there may be only one sender to consider. Alternatively, when the user engagement metrics are not available (e.g., the channel-sender combination 200D), the channel selection process may use a set of channel selection rules 204, which may specify an order of channels to use. A hybrid approach (using both metrics and rules) may also be used. In some embodiments, there may be cost-driven components in that metric (e.g., a weighted sum of engagement-based metric and a cost-based metric). In some embodiments, there may be cost-ceiling criterion applied to the selected channel. The ceiling may be specific to each user, for a given timeframe, for a particular campaign, and so on. If the cost of the current selection exceeds the ceiling, the selection process may select the next best channel.

This selection and fallback can use the recipient profile database 144, compliance rules database 146, and/or device registration database 148 described in FIG. 1, to help ensure that communication attempts are optimized for delivery success and compliant with applicable regulations. For example, engagement metrics might reveal that a specific recipient consistently engages with authentication messages via push notifications during business hours (channel 160B) but prefers SMS (channel 160A) during evenings, allowing the system to adaptively route messages based on time of day. By evaluating channel options, sender identities, and fallback mechanisms based on engagement metrics, the system can significantly improve message delivery success rates while respecting recipient preferences and regulatory requirements. This architecture can also implement asynchronous processing with operations tracking, where outbound transmissions are validated and queued, then processed in the background. Each operation can be assigned a unique identifier that allows the system to track and report on the aggregated delivery status across multiple recipients, providing visibility into queued, sent, delivered, read, undelivered, and failed message metrics.

In an omnichannel message delivery system, example scenarios can help demonstrate the practical application of the channel selection process illustrated in FIG. 2. For authentication scenarios, the system may evaluate channel-sender combination 200A (channel 160A/SMS with sender 170A/short code) against channel-sender combination 200C (channel 160B/WhatsApp with sender 170C/business account), where engagement metrics 180C indicating higher conversion rates can influence selection of channel-sender combination 200C despite potentially lower delivery rates. For appointment notifications, the system may compare channel-sender combination 200A (channel 160A/SMS with sender 170A/short code) against channel-sender combination 200B (channel 160A/SMS with sender 170B/long code), where engagement metrics 180B showing superior read rates and confirmation responses can justify selection of channel-sender combination 200B. For document delivery notifications, the system can evaluate channel-sender combination 200A (channel 160A/SMS with sender 170A/short code) against channel-sender combination 200C (channel 160B/WhatsApp with sender 170C/business account), where engagement metrics 180C demonstrating superior document access rates may outweigh lower initial open rates, resulting in channel-sender combination 200C being selected as the optimal channel-sender combination 202 for document delivery use cases.

FIG. 3 is a block diagram of an example omni-channel communication component 142, in accordance with an embodiment. Omni-channel communication component 142 includes message queue 306, dequeue engine 302, audience management 310, and execution management engine 340. Audience management 310 can include a filter generation module 312, audience generation module 314, channel selection module 316, compliance rules engine 318, preference management and personalization module 320, and delivery and database optimization module 322. In various embodiments, omni-channel communication component 142 can include more or fewer components in different configurations than those depicted in FIG. 3.

Message queue 306 stores incoming messages and audience-targeted communications that need to be processed and delivered to recipients. Dequeue engine 302 retrieves messages from message queue 306 and coordinates with audience management 310 to determine the appropriate audience and delivery paths for each communication.

Audience management 310 serves as the intelligence system for defining, generating, and managing messaging audiences. Filter generation module 312 processes API requests to create messaging audiences and generates filter definitions comprising criteria for selecting members of the audience from a database based on specified parameter values. These filter definitions can include criteria, such as geographic location, industry classification, custom field values, tag values, and prior engagement metrics as specified in the API request.

Audience generation module 314 implements the different audience generation modes specified in API requests, including, for example, an ad-hoc audience generation mode and a snapshot audience generation mode. When operating in ad-hoc audience generation mode, the module may apply filter definitions to identify recipients satisfying the defined criteria at the time of message transmission. In snapshot audience generation mode, the module may identify recipients corresponding to a previously generated audience that satisfied the filter definition at an earlier point in time.

Channel selection module 316 performs communication channel selection for each recipient in the generated audience. Using historical user engagement data, the module may apply communication channel selection rules to identify the communication channel that yields an optimal value of a chosen user engagement metric for each recipient. This enables the platform to select an effective communication endpoint identifier associated with each recipient.

In some embodiments, compliance rules engine 318 ensures communications adhere to regional regulations by identifying jurisdictions associated with recipients and filtering available communication channels or adjusting delivery timing based on applicable rules. This module may help ensure that message delivery complies with jurisdiction-specific time-of-day restrictions and other regulatory requirements.

In some embodiments, preference management and personalization module 320 obtains and enforces recipient preference data indicating opt-in or opt-out status for different communication types across different channels. Additionally, this module may identify variable placeholders in communications, retrieves recipient-specific data, and generates personalized communications by populating these placeholders with the appropriate data for each recipient.

In some embodiments, delivery, and database optimization module 322 optimizes the database performance when evaluating complex filters across large contact databases. This module designates subsets of custom fields as filterable, maintains database indexes for these fields, and efficiently evaluates filter expressions using these indexes to determine audience membership. The module can also reject definitions that attempt to filter on non-filterable custom fields and limit the maximum number of custom fields that can be designated as filterable to optimize database performance.

After audience management 310 determines the appropriate audience and delivery paths, execution management engine 340 implements the selected communication strategies by communicating with the appropriate routing providers 150A-N. Execution management engine 340 may also handle message delivery tracking, and receives feedback from routing providers, which can then be used to update engagement metrics for future optimizations. This may include tracking total contacts, attempts, queued messages, successful deliveries, failed deliveries, and various engagement metrics, while providing real-time access to these statistics during transmission.

Execution management engine 340 may implement asynchronous processing for large-scale message delivery operations. Each operation may be assigned a unique identifier that allows the system to track and report on aggregated delivery status across multiple recipients. The tracking statistics may include detailed metrics on the number of recipients, delivery attempts, messages in various states (e.g., queued, sent, scheduled, delivered, read), and failure counts (undelivered, failed, canceled). This operational data may be available in real-time, allowing organizations to monitor campaign progress and quickly identify any delivery issues that may require attention or alternate communication strategies.

This architecture implements the audience management and communication processes described herein, with each component playing a role in ensuring audience targeting and message delivery. The audience management 310 works with execution management engine 340 to enable organizations to deliver targeted, personalized communications at scale while maintaining system performance, ensuring compliance, and optimizing recipient engagement.

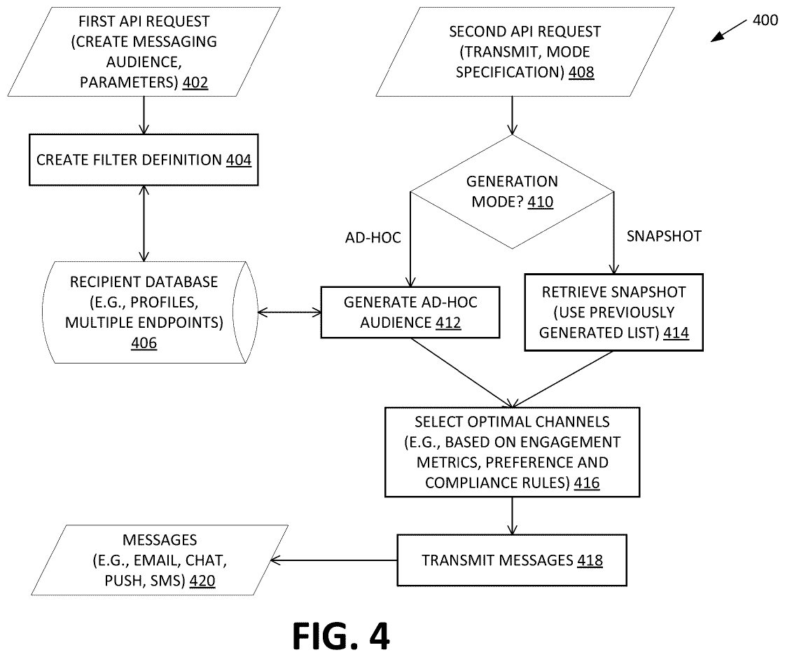

FIG. 4 is a flow diagram of an example method 400 for audience management, in accordance with an embodiment. The method 400 illustrates the process flow for creating a messaging audience, determining the audience generation mode, and transmitting communications to the selected audience. The method 400 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the audience management 310 of omni-channel communication component 142 of FIG. 3. Although shown in a particular sequence or order, unless otherwise specified, the order of the operations may be modified.

The process may begin with receiving a first API request 402 to create a messaging audience. This request may specify one or more values of respective parameters for the messaging audience, such as geographic location, industry classification, custom field values, tag values, or prior engagement metrics. Based on these parameters, a filter definition may be created at block 404, comprising one or more criteria for selecting recipients from a database.

The filter definition interacts with recipient database 406, which contains recipient profiles with multiple communication endpoint identifiers for various channels (e.g., phone numbers, email addresses, usernames for messaging platforms). The recipient database 406 may also store custom fields, tags, historical engagement data, and preference settings that can be used in filter definitions to target specific audience segments.

Subsequently, a second API request 408 may be received to transmit a communication to the messaging audience. This request may specify a messaging audience generation mode, represented by either an ad-hoc audience generation mode or a snapshot audience generation mode. At decision point 410, the system may determine which audience generation mode has been specified in the request.

If the ad-hoc audience generation mode is specified, the process follows the “AD-HOC” path, and at block 412, the system generates an audience by applying the filter definition to identify recipients who currently satisfy the criteria. This dynamic audience generation can help ensure that the most up-to-date recipient data is used for message targeting.

Alternatively, if the snapshot audience generation mode is specified, the process follows the “SNAPSHOT” path, and at block 414, the system retrieves a previously generated audience that satisfied the filter definition at an earlier point in time. This mode can allow for consistent messaging to a fixed group of recipients across multiple communications.

After the appropriate audience has been determined, the process may move to block 416, where optimal communication channels are selected for each recipient in the audience. This selection may be based on multiple factors. The factors may include historical engagement metrics (e.g., delivery rates, read confirmations, and conversion statistics), recipient preference data indicating opt-in or opt-out status for different communication types, and compliance rules specific to the jurisdictions associated with each recipient. For each recipient, the system may identify their profile containing multiple communication endpoint identifiers, select the communication channel that yields an optimal value of a chosen user engagement metric, and then select the corresponding communication endpoint identifier associated with that channel.

Finally, at block 418, messages containing the communication content are transmitted to the selected communication channels for each recipient in the audience. These messages 420 may take various forms, such as email, chat messages, push notifications, or SMS, depending on the optimal channel selected for each recipient in the audience.

Throughout this process, the system may perform additional operations not explicitly shown in the diagram, such as transforming message content to suit the requirements of each channel, scheduling deliveries based on recipient time zones and preferred time windows, tracking engagement metrics for continuous optimization, and generating operation tracking statistics to provide real-time visibility into the transmission progress.

The system may support multiple audience creation methods concurrently. For example, static explicit audiences can be created by explicitly adding contact IDs to an audience. Static filter audiences may utilize a filter definition with a snapshot parameter set to true, capturing contacts who match the filter criteria at the time of creation. Dynamic filter audiences may be created using a filter definition with the snapshot parameter set to false or omitted, continuously updating audience membership as contact attributes change to match or not match the filter.

The system may include contact management including storage of multiple communication endpoints per contact across various channels, such as phone, WhatsApp, email, and others. The system may support standard contact fields like first_name and last_name as well as custom fields. To optimize database performance, only a subset of custom fields may be designated as filterable with appropriate database indexes. Contacts may be organized using tags for efficient grouping and filtering. The system can enable reference to contact attributes using template variables, such as ${CommunicationPlatform.Contact.first_name} or ${CommunicationPlatform.Contact.custom_fields.field_name} for personalization.

Message personalization may be enabled through several mechanisms. For example, inline variables may support per-recipient personalization for up to 1,000 recipients per request. For larger scale operations, stored contact attributes may be used to personalize messages for up to 1 million recipients per request. The system may provide default variable values to handle missing personalization data and supports template-based content that adapts to different channels with appropriate fallback behavior.

The system may implement channel management through agent pools that group communication endpoints across different channels. This can enable automatic channel selection and fallback, such as trying RCS first, then falling back to SMS if unavailable. Mixed-channel message delivery is supported in a single request, allowing messages to be sent to both SMS and WhatsApp recipients simultaneously. Messages may be processed asynchronously with real-time operation tracking.

The system may provide asynchronous processing with operation tracking for large-scale message delivery. Real-time aggregated delivery statistics may include queued, sent, delivered, read, undelivered, and failed messages. The system may optimize payload handling for different message types. The system may support, for example ten thousand recipients for identical messages and thousand recipients for personalized messages. The system may use efficient database indexing and filtering techniques.

This method enables organizations to efficiently target communications to relevant recipients while optimizing channel selection, ensuring regulatory compliance, and respecting recipient preferences. By supporting both ad-hoc and snapshot audience generation modes, the system provides flexibility in how audiences are defined and maintained over time, addressing the challenges of managing communications at scale.

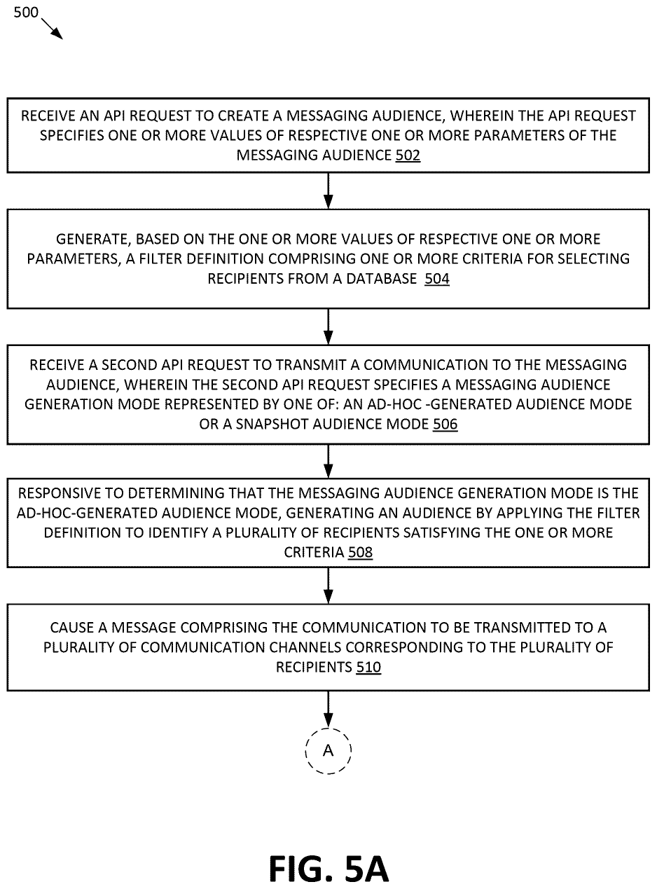

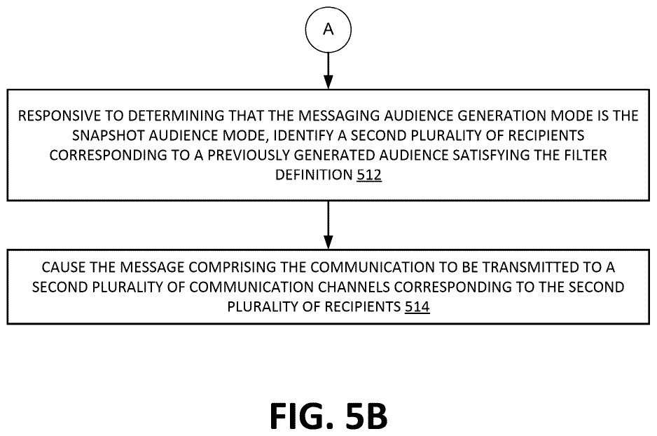

FIGS. 5A and 5B are a flow diagram of an example method 500 for audience management for communication services platforms, in accordance with an embodiment. Method 500 can be performed by processing logic that can comprise hardware (e.g., circuitry, dedicated logic, etc.), computer-readable instructions such as software or firmware (e.g., run on a general-purpose computing system or a dedicated machine), or a combination thereof. For instance, an example system can include a memory, and a processing device coupled to the memory device to perform operations comprising the blocks of method 500. Method 500 can also be associated with a set of instructions stored on a non-transitory computer-readable medium (e.g., magnetic disk, optical disk). The instructions, when executed by a processing device, can cause the processing device to perform operations comprising the blocks of method 500. In some embodiments, method 500 is performed by customer 132 or communication services platform 130 of FIG. 1. The method may be performed by the audience management 310 of omni-channel communication component 142 or other components of omni-channel communication component 142 shown in FIG. 3. In some embodiments, method 500 is performed by computing system 600 of FIG. 6. In some embodiments, blocks depicted in FIGS. 5A and 5B could be performed simultaneously or in a different order than depicted. Various embodiments can include additional blocks not depicted in FIGS. 5A and 5B or a subset of blocks depicted in FIGS. 5A and 5B.

Referring to FIG. 5A, at block 502, the processing logic receives an API request to create a messaging audience. The API request may specify one or more values of respective one or more parameters of the messaging audience. In some embodiments, the one or more parameters include user-defined metadata tags associated with the messaging audience. The filter definition may be generated based on the user-defined metadata tags such that applying the filter definition returns recipients that have all the user-defined metadata tags. In another embodiment, the one or more criteria include at least one of: geographic location, industry classification, custom field values, tag values, and prior engagement metrics.

At block 504, the processing logic generates, based on the one or more values of respective one or more parameters, a filter definition including one or more criteria for selecting recipients from a database. In some embodiments, applying the filter definition includes evaluating filter expressions to determine membership (recipients) of the audience. In some embodiments, applying the filter definition includes designating a subset of custom fields as filterable for use in audience definitions, maintaining database indexes for the designated filterable custom fields, and evaluating filter expressions containing designated filterable custom fields using the database indexes to determine membership of the audience. In some embodiments, the processing logic rejects any definition in the filter definitions that attempt to filter on custom fields that are not designated as filterable. Additionally, the processing logic may limit the maximum number of custom fields that can be designated as filterable for optimizing database performance.

At block 506, the processing logic receives a second API request to transmit a communication to the messaging audience. The second API request may specify a messaging audience generation mode represented by one of: an ad-hoc audience generation mode or a snapshot audience generation mode. The communication may include various types of content, such as promotional messages, transactional notices, or authentication codes.

At block 508, responsive to determining that the messaging audience generation mode is the ad-hoc audience generation mode, the processing logic generates an audience by applying the filter definition to identify a plurality of recipients satisfying the one or more criteria. This dynamic application of the filter definition can help ensure that the most current recipient data is used to determine audience membership at the time of transmission.

At block 510, the processing logic causes a message comprising the communication to be transmitted to a plurality of communication channels corresponding to the plurality of recipients. In some embodiments, the processing logic identifies variable placeholders in the communication, retrieves recipient-specific data for each recipient in the plurality of recipients, generates personalized communications by populating the variable placeholders with the recipient-specific data for each recipient, and causes the personalized communications to be transmitted to the plurality of communication channels.

In various embodiments, before transmitting the message, additional operations may be performed. The processing logic may identify jurisdictions associated with the plurality of recipients, retrieve compliance rules specific to the identified jurisdictions, and select a communication channel among the plurality of communication channels based on the compliance rules. Alternatively, or additionally, the processing logic may cause the message to be transmitted during time windows that comply with time-of-day restrictions according to the compliance rules. The processing logic may also obtain preference data indicating opt-in or opt-out status for different communication types across different channels for each recipient and select a communication channel among the plurality of communication channels based on the preference data.

In some embodiments, the processing logic may schedule message delivery for each contact based on recipient-specific parameters and cause the message to be transmitted to the recipients at their respective scheduled delivery time. The processing logic may determine a local time zone for each recipient, identify preferred time windows for communication based on historical engagement data for each recipient, and cause the message to be transmitted to the recipients based on the local time zone and preferred time windows for each recipient. Suppose there are multiple users that have “similar” destination addresses (e.g., same MCC/MNC), the processing logic may avoid sending all those messages at a same time and instead use randomization to schedule the send time. The processing logic may identify an optimal window (e.g., between 2 and 4 pm) for a given user. The processing logic may then send out the communication at a random time during the optimal window, rather than at a specific time. In some embodiments, the processing logic may schedule message delivery by identifying preferred time windows for communication based on historical engagement data, identifying contacts with similar optimal delivery time windows, and batching communications for contacts with similar time windows.

Referring to FIG. 5B, in some embodiments, at block 512, responsive to determining that the messaging audience generation mode is the snapshot audience mode, the processing logic identifies a previously defined plurality of recipients corresponding to a previously generated audience satisfying the filter definition. This allows for consistent messaging to a fixed group of recipients across multiple communications over time.

At block 514, the processing logic may cause the message including the communication to be transmitted via a second plurality of communication channels to the previously defined plurality of recipients. As with the ad-hoc audience, personalization, compliance verification, and preference-based channel selection may also be applied to this snapshot audience.

In some embodiments, after transmitting messages to either audience type, the processing logic may track engagement metrics for communications sent to the audience, identify one or more recipients with engagement metrics below a threshold, and cause the message to be transmitted to the one or more recipients via a secondary communication channel. The processing logic may also generate operation tracking statistics comprising at least one of: total contacts, attempts, queued messages, successful deliveries, failed deliveries, and engagement metrics, and provide real-time access to the operation tracking statistics during transmission of communications to the plurality of recipients.

For each recipient in either audience, additional processing may occur, as described in other embodiments. For example, the processing logic may identify a recipient profile of the recipient, including a plurality of communication endpoint identifiers associated with the recipient. Each communication endpoint identifier is associated with a respective communication channel of the plurality of communication channels. The processing logic may then select, by applying a set of communication channel selection rules to historical user engagement data, among the plurality of communication channels, a first communication channel that yields an optimal value of a chosen user engagement metric. The processing logic may then select, among the plurality of communication endpoint identifiers associated with the recipient, a first communication endpoint identifier associated with the first communication channel and causes the message comprising the communication to be transmitted to the first communication endpoint identifier.

In some embodiments, the processing logic may receive a response from a recipient in the plurality of recipients, and in response to receiving the response, establish a messaging-based conversation session associated with the recipient and provide two-way communication with the recipient via the conversation session. In some embodiments, the processing logic routes subsequent communications with the recipient via the conversation session. The processing logic may also track engagements from communications sent to recipients in the plurality of recipients and use data corresponding to the engagements to refine selection of preferred communication channels for future communications.

This method enables organizations to efficiently target communications to relevant recipients using either dynamic, real-time audience generation or consistent snapshot audiences, while optimizing channel selection, ensuring regulatory compliance, and respecting recipient preferences.

FIG. 6 is a block diagram illustrating an example computer system 600, in accordance with embodiments of the present disclosure. Computer system 600 may be client devices 120A-N, servers 130-140, or routing providers 150A-N, as described above with reference to FIG. 1. Computer system 600 may operate in the capacity of a server or an endpoint machine in endpoint-server network environment, or as a peer machine in a peer-to-peer (or distributed) network environment. The machine may be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 600 includes processing device 602 (e.g., one or more processors or cores), main memory 604 (e.g., read-only memory (ROM), flash memory, dynamic random access memory (DRAM) such as synchronous DRAM (SDRAM), double data rate (DDR SDRAM), or DRAM (RDRAM), etc.), static memory 606 (e.g., flash memory, static random access memory (SRAM), etc.), and data storage device 608, which communicate with each other via bus 610.

Processing device 602 represents one or more general-purpose processing devices such as a microprocessor, central processing unit, or the like. More particularly, processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute instructions 612 (e.g., for storing contextual data with context schemas) for performing the operations discussed herein.

Computer system 600 may further include network interface device 614. Computer system 600 also may include display device 616 (e.g., a liquid crystal display (LCD) or a cathode ray tube (CRT)), alphanumeric input device 618 (e.g., a keyboard, and alphanumeric keyboard, a motion sensing input device, touch screen), cursor control device 620 (e.g., a mouse), and signal generation device 622 (e.g., a speaker). In some embodiments, computer system 600 may not include display device 616, alphanumeric input device 618, and/or cursor control device 620 (e.g., in a headless configuration).

Data storage device 608 may include a non-transitory machine-readable storage medium 624 (also computer-readable storage medium) on which is stored one or more sets of instructions 612 (e.g., for storing contextual data with context schemas) embodying any one or more of the methodologies or functions described herein. Instructions 612 may also reside, completely or at least partially, within main memory 604 or within the processing device 602 during execution thereof by computer system 600, main memory 604 and processing device 602 also constituting machine-readable storage media. Instructions 612 may further be transmitted or received over network 626 via network interface device 614.

In some embodiments, instructions 612 include instructions for storing contextual data with context schemas, as described herein. While computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method, comprising:
receiving, by a processing device, an application programming interface (API) request to create a messaging audience, wherein the API request specifies one or more values of respective one or more parameters of the messaging audience;
generating, based on the one or more values of respective one or more parameters, a filter definition comprising one or more criteria for selecting members of the audience from a database;
receiving a second API request to transmit a communication to the messaging audience, wherein the second API request specifies a messaging audience generation mode;
responsive to determining that the messaging audience generation mode is an ad-hoc audience generation mode, generating an audience by applying the filter definition to identify a plurality of recipients satisfying the one or more criteria; and
causing a message comprising the communication to be transmitted to a plurality of communication channels corresponding to the plurality of recipients.

2. The method of claim 1, further comprising:
responsive to determining that the messaging audience generation mode is a snapshot audience generation mode, identifying a previously defined plurality of recipients corresponding to a previously generated audience satisfying the filter definition; and
causing the message comprising the communication to be transmitted via a second plurality of communication channels to the previously defined plurality of recipients.

3. The method of claim 1, further comprising:
for each recipient of the plurality of recipients:
identifying a recipient profile of the recipient, the recipient profile including a plurality of communication endpoint identifiers associated with the recipient, wherein each communication endpoint identifier of the plurality of communication endpoint identifiers is associated with a respective communication channel of the plurality of communication channels;
selecting, by applying a set of communication channel selection rules to historical user engagement data, among the plurality of communication channels, a first communication channel that yields an optimal value of a chosen user engagement metric;
selecting, among the plurality of communication endpoint identifiers associated with the recipient, a first communication endpoint identifier associated with the first communication channel; and
causing the message comprising the communication to be transmitted to the first communication endpoint identifier.

4. The method of claim 1, wherein the one or more criteria comprise at least one of: geographic location, industry classification, custom field values, tag values, and prior engagement metrics.

5. The method of claim 1, wherein applying the filter definition comprises:
evaluating filter expressions to determine membership of the audience.

6. The method of claim 1, further comprising:
identifying a jurisdiction associated with each recipient of the plurality of recipients;
retrieving compliance rules specific to the identified jurisdiction; and
causing the message to be transmitted during a time window that complies with time-of-day restrictions according to the compliance rules.

7. The method of claim 1, further comprising:
receiving, for at least one recipient in the plurality of recipients, channel-specific preference settings for different types of content across different communication channels; and
selecting a communication channel for the at least one recipient based on the channel-specific preference settings.

8. The method of claim 1, further comprising:
tracking engagements from communications sent to recipients in the plurality of recipients; and
using data corresponding to the engagements to refine selection of preferred communication channels for future communications.

9. The method of claim 1, wherein the one or more parameters comprise user-defined metadata tags associated with the messaging audience, wherein the filter definition is generated based on the user-defined metadata tags such that applying the filter definition returns recipients that have all the user-defined metadata tags.

10. The method of claim 1, further comprising:
identifying variable placeholders in the communication;
retrieving recipient-specific data for each recipient in the plurality of recipients;
generating personalized communications by populating the variable placeholders with the recipient-specific data for each recipient; and
causing the personalized communications to be transmitted to the plurality of communication channels.

11. A system comprising:
a memory device; and
a processing device coupled to the memory device, the processing device to perform operations comprising:
receiving an API request to create a messaging audience, wherein the API request specifies one or more values of respective one or more parameters of the messaging audience;
generating, based on the one or more values of respective one or more parameters, a filter definition comprising one or more criteria for selecting members of the audience from a database;
receiving a second API request to transmit a communication to the messaging audience, wherein the second API request specifies a messaging audience generation mode;
responsive to determining that the messaging audience generation mode is an ad-hoc audience generation mode, generating an audience by applying the filter definition to identify a plurality of recipients satisfying the one or more criteria; and
causing a message comprising the communication to be transmitted to a plurality of communication channels corresponding to the plurality of recipients.

12. The system of claim 11, wherein the operations further comprise:
responsive to determining that the messaging audience generation mode is a snapshot audience generation mode, identifying a previously defined plurality of recipients corresponding to a previously generated audience satisfying the filter definition; and
causing the message comprising the communication to be transmitted via a second plurality of communication channels to the previously defined plurality of recipients.

13. The system of claim 11, wherein the operations further comprise:
for each recipient of the plurality of recipients:
identifying a recipient profile of the recipient, the recipient profile including a plurality of communication endpoint identifiers associated with the recipient, wherein each communication endpoint identifier of the plurality of communication endpoint identifiers is associated with a respective communication channel of the plurality of communication channels;
selecting, by applying a set of communication channel selection rules to historical user engagement data, among the plurality of communication channels, a first communication channel that yields an optimal value of a chosen user engagement metric;
selecting, among the plurality of communication endpoint identifiers associated with the recipient, a first communication endpoint identifier associated with the first communication channel; and
causing the message comprising the communication to be transmitted to the first communication endpoint identifier.

14. The system of claim 11, wherein the one or more criteria comprise at least one of: geographic location, industry classification, custom field values, tag values, and prior engagement metrics.

15. The system of claim 11, wherein applying the filter definition comprises:
evaluating filter expressions to determine membership of the audience.

16. The system of claim 11, wherein the operations further comprise:
identifying a jurisdiction associated with each recipient of the plurality of recipients;
retrieving compliance rules specific to the identified jurisdiction; and
causing the message to be transmitted during a time window that complies with time-of-day restrictions according to the compliance rules.

17. The system of claim 11, wherein the operations further comprise:
receiving, for at least one recipient in the plurality of recipients, channel-specific preference settings for different types of content across different communication channels; and
selecting a communication channel for the at least one recipient based on the channel-specific preference settings.

18. The system of claim 11, wherein the operations further comprise:
tracking engagements from communications sent to recipients in the plurality of recipients; and
using data corresponding to the engagements to refine selection of preferred communication channels for future communications.

19. The system of claim 11, wherein the one or more parameters comprise user-defined metadata tags associated with the messaging audience, wherein the filter definition is generated based on the user-defined metadata tags such that applying the filter definition returns recipients that have all the user-defined metadata tags.

20. A non-transitory computer-readable medium comprising instructions that, when executed by a processing device, cause the processing device to perform operations comprising:
receiving an API request to create a messaging audience, wherein the API request specifies one or more values of respective one or more parameters of the messaging audience;
generating, based on the one or more values of respective one or more parameters, a filter definition comprising one or more criteria for selecting members of the audience from a database;
receiving a second API request to transmit a communication to the messaging audience, wherein the second API request specifies a messaging audience generation mode;
responsive to determining that the messaging audience generation mode is an ad-hoc audience generation mode, generating an audience by applying the filter definition to identify a plurality of recipients satisfying the one or more criteria; and
causing a message comprising the communication to be transmitted to a plurality of communication channels corresponding to the plurality of recipients.
